(19) United States
(12) Patent Application Publication
(10) Pub. No.: US 2026/0255104 A1
(43) Pub. Date: Aug. 27, 2026

(54) METHOD AND APPARATUS FOR CALIBRATING SOUND QUALITY OF EARPHONE, AND DEVICE AND STORAGE MEDIUM

(71) Applicant: GOERTEK TECHNOLOGY CO., LTD, Qingdao, Shandong (CN)

(72) Inventors: Heqiang LV, Qingdao, Shandong (CN); Qiang CHEN, Qingdao, Shandong (CN); Jie WU, Qingdao, Shandong (CN); Chunyan LIU, Qingdao, Shandong (CN)

(21) Appl. No.: 18/856,170

(22) PCT Filed: Jun. 29, 2022
(86) PCT No.: PCT/CN2022/102542

§ 371 Date: Oct. 11, 2024

(30) Foreign Application Priority Data
Apr. 26, 2022 (CN) 202210445060.9

(51) Int. Cl. H04R 3/04; H04R 1/10; H04R 1/22; H04R 29/00

(52) U.S. Cl. CPC H04R 3/04; H04R 1/1091; H04R 1/227; H04R 29/001

(57) ABSTRACT

Disclosed are a method and apparatus for calibrating the sound quality of an earphone, and a device and a storage medium. The method includes: acquiring frequency response data of an earphone to be calibrated and a preset target frequency response curve; according to the target frequency response curve, determining whether the frequency response data meets the calibration condition; if it is determined that the frequency response data meets the calibration condition, performing section dividing on the frequency response data, to obtain a filter parameter by means of searching based on a preset genetic algorithm, and calibrating the frequency response data according to the filter parameter, to obtain new frequency response data; and when it is determined that the new frequency response data does not meet the calibration condition, determining to calibrate the sound quality of the earphone to be calibrated based on the filter parameter.

The present application claims priority to Chinese Patent Application No. 202210445060.9, entitled “METHOD AND APPARATUS FOR CALIBRATING SOUND QUALITY OF EARPHONE, AND DEVICE AND STORAGE MEDIUM” filed with China Patent Office on Apr. 26, 2022, the entire contents of which are incorporated herein by reference.

### TECHNICAL FIELD

The present disclosure relates to a technical field of digital signal processing, and particularly, to a method and an apparatus for calibrating sound quality of earphones, and a device and a storage medium.

### DESCRIPTION OF RELATED ART

With the improvement of people's quality of life and the increase in travel needs, people's demand for the sound quality of True Wireless Stereo (TWS) earphones is increasing. The sound effect consistency between the left and right earphones of TWS earphones becomes increasingly important in people's perception of sound quality.

At present, the consistency of effects between the left and right earphones of TWS earphones is ensured generally by segmented adjustment method or a manual adjustment method. However, these two earphone calibration methods have great defects. On the one hand, the segmented adjustment method may result in a situation where tap positions are difficult to define and the segmenting operation is complicated and the production efficiency is low. On the other hand, adjusting Equalizer (EQ) parameters by using the manual adjustment method not only requires high experience from the operator, but also has a phenomenon of low operating efficiency.

In summary, the existing method of calibrating the left and right earphones has defects such as complex operation and low production efficiency.

### SUMMARY

A main object of the present disclosure is to provide a method and an apparatus for calibrating sound quality of an earphone, and a device and a storage medium, aiming at providing a simpler and faster setting of EQ parameters to improve the accuracy of calibration such that sound effects of a left earphone and a right earphone of the earphone to be calibrated are consistent, thereby improving the quality of the sound quality of the product and the production efficiency of same.

To achieve the above object, the present disclosure provides a method of calibrating sound quality of an earphone, including:
acquiring frequency response data of an earphone to be calibrated and a preset target frequency response curve;
determining whether the frequency response data meets the calibration condition according to the target frequency response curve;
if it is determined that the frequency response data meets the calibration condition, performing section dividing on the frequency response data, to obtain filter parameters by means of searching based on a preset genetic algorithm, and calibrating the frequency response data according to the filter parameters, to obtain new frequency response data; and
determining to calibrate the sound quality of the earphone to be calibrated based on the filter parameters when it is determined that the new frequency response data does not meet the calibration condition.

Optionally, determining whether the frequency response data meets a calibration condition according to the target frequency response curve includes:
determining main gain information corresponding to the earphone to be calibrated;
shifting the frequency response data according to the main gain information to determine whether the frequency response data is within a calibration threshold range corresponding to the target frequency response curve;
if it is determined that the frequency response data is within the calibration threshold range, determining that the frequency response data does not meet the calibration condition; and
if it is determined that the frequency response data is not within the calibration threshold range, determining that the frequency response data meets the calibration condition.

Optionally, determining the main gain information corresponding to the earphone to be calibrated includes:
calculating differences between the frequency response data and the target frequency response curve at corresponding frequency values;
calculating an average value of all the differences within the calibration threshold range; and
using the average value as the main gain information corresponding to the earphone to be calibrated.

Optionally, performing the section dividing on the frequency response data, to obtain the filter parameters by means of searching based on the preset genetic algorithm includes:
using an intersection between the frequency response data and the target frequency response curve as a section division point, and performing the section dividing according to the section division point to obtain a section to be calibrated;
acquiring a maximum deviation position between the frequency response data and the target frequency response curve, and determining the section to be calibrated to which the maximum deviation position belongs, as a current section to be calibrated;
determining a value range of the filter parameters according to the current section to be calibrated; and
acquiring genetic factor information based on the preset genetic algorithm, and obtaining the filter parameters according to the genetic factor information and the value range.

Optionally, calibrating the frequency response data according to the filter parameters, to obtain the new frequency response data includes:
obtaining a coefficient of a filter frequency response function according to the filter parameters;
determining filter frequency response information according to the coefficient; and
superimposing the filter frequency response information on the frequency response data to calibrate the frequency response data, to obtain the new frequency response data.

Optionally, the method further includes: before determining to calibrate the sound quality of the earphone to be calibrated based on the filter parameters when it is determined that the new frequency response data does not meet the calibration condition,
determining whether the new frequency response data meets the calibration condition; and
if the new frequency response data meets the calibration condition, re-executing the step of performing section dividing on the frequency response data, to obtain filter parameters by means of searching based on a preset genetic algorithm, and calibrating the frequency response data according to the filter parameters, to obtain new frequency response data.

Optionally, the method further includes: after determining to calibrate the sound quality of the earphone to be calibrated based on the filter parameters,
writing the filter parameters into the earphone to be calibrated, and when it is retested that the frequency response data of the earphone to be calibrated, after the filter parameters are written, does not meet the calibration condition, determining that the sound qualities of a left earphone and a right earphone of the earphone to be calibrated are consistent.

In addition, to achieve the above object, the present disclosure also provides an apparatus for calibrating sound quality of an earphone, including:
an acquisition module configured to acquire frequency response data of an earphone to be calibrated and a preset target frequency response curve;
a determination module configured to determine whether the frequency response data meets a calibration condition according to the target frequency response curve;
an update module configured to perform section dividing on the frequency response data, to obtain filter parameters by means of searching based on a preset genetic algorithm and calibrate the frequency response data according to the filter parameters, to obtain new frequency response data when it is determined that the frequency response data meets the calibration condition; and
an execution module configured to determine to calibrate the sound quality of the earphone to be calibrated based on the filter parameters when it is determined that the new frequency response data does not meet the calibration condition.

Each functional module of the apparatus for calibrating the sound quality of an earphone of the present disclosure implements the steps of the method of calibrating the sound quality of an earphone of the present disclosure as described above during operation.

In addition, to achieve the above object, the present disclosure also provides a terminal device, including: a memory, a processor, and a program for calibrating sound quality of an earphone stored in the memory and executable by the processor, wherein the program for calibrating sound quality of an earphone, when executed by the processor, implements the steps of the method of calibrating sound quality of an earphone as described above.

In addition, to achieve the above object, the present disclosure also provides a storage medium for calibrating sound quality of an earphone, on which a program for calibrating sound quality of an earphone is stored, wherein when the program for calibrating sound quality of an earphone is executed by a processor, the steps of the method of calibrating sound quality of an earphone as described above are implemented.

In the present disclosure, a target frequency response curve is provided, a control center firstly determines mainGain of the earphone to be calibrated, and shifts the frequency response data up and down as a whole to a position closest to the target frequency response curve according to the mainGain to obtain an updated EQBefore, then continues to determine whether the EQBefore needs to be calibrated, and then automatically sets EQ filter parameters according to a preset genetic algorithm, and approximates the frequency response data of the earphone to be calibrated to a calibration threshold value within an acceptable upper and lower range centered on the target frequency response curve, to achieve a close frequency response curve for all products, a balanced sound quality between the left and right earphones, and improve product consistency.

Compared with traditional calibration methods for an earphone, the present disclosure provides a target frequency response curve, and ensures that the sound qualities a left earphone and a right earphone are consistent, by automatically retrieving filter parameters through a preset algorithm main module, improving the accuracy of the earphone calibration, so that effectively avoid the difficulties in defining calibration segments and the complexity of calibration operations present in existing technologies. As a result, by simplifying the earphone calibration process, the quality of the sound quality of the product and the production efficiency of same are improved.

### BRIEF DESCRIPTION OF DRAWINGS

FIG. 1 is a flow chart of a first embodiment of a method of calibrating sound quality of an earphone according to the present disclosure;

FIG. 2 is a main flow chart of an automatic EQ calibration algorithm according to an embodiment of a method of calibrating the sound quality of an earphone of the present disclosure;

FIG. 3 is a schematic diagram of curves of EQBefore, Golden and Limit involved in an embodiment of a method of calibrating sound quality of an earphone according to the present disclosure;

FIG. 4 is a flow chart of a second embodiment of a method of calibrating sound quality of an earphone according to the present disclosure;

FIG. 5 is a schematic diagram of a workflow of an automatic EQ calibration algorithm for a production line according to an embodiment of a method of calibrating the sound quality of an earphone of the present disclosure;

FIG. 6 is a logic flow diagram of a genetic algorithm involved in an embodiment of a method of calibrating sound quality of an earphone according to the present disclosure;

FIG. 7 is a schematic diagram of modules of the apparatus for calibrating sound quality of an earphone according to the present disclosure; and

FIG. 8 is a structural schematic diagram of a terminal device involved in an embodiment of the present disclosure.

### DETAILED DESCRIPTIONS

It should be understood that the specific embodiments described herein are only used to explain the present disclosure, and are not intended to limit the present disclosure.

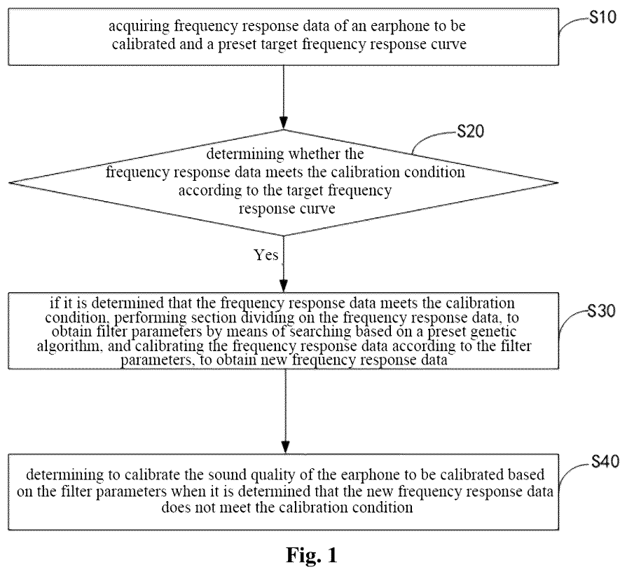

An embodiment of the present disclosure provides a method of calibrating sound quality of an earphone. Referring to FIG. 1, FIG. 1 is a flow chart of a first embodiment of a method of calibrating sound quality of an earphone according to the present disclosure.

Reference will now be made in detail to exemplary embodiments, examples of which are illustrated in the accompanying drawings. When the following description refers to the drawings, unless otherwise indicated, the same numbers in different drawings represent the same or similar elements. The implementations described in the following exemplary embodiments do not represent all implementations consistent with the present disclosure.

In the embodiment, the method of calibrating sound quality of an earphone provided by the present disclosure is applied to a terminal device for calibrating sound qualities of a left earphone and a right earphone, and may be specifically executed by a control center in the terminal device. The method of calibrating sound quality of an earphone includes:

Step S10: acquiring frequency response data of an earphone to be calibrated and a preset target frequency response curve.

In the embodiment, a control center directly obtains a target frequency response curve preset in the system, and indirectly obtains frequency response data of an earphone to be calibrated by using an acoustic testing software for earphones.

It should be noted that the frequency response data is outputted based on the acoustic testing software testing the earphone to be calibrated, and can be represented by a EQBefore curve (frequency response curve to be calibrated). In the embodiment, the frequency response data is shown in Table 1. Table 1 shows a frequency response data 101 pattern of the earphone to be calibrated, the first row is a 1/12 octave distribution of a frequency of 20-20 KHz, i.e., a frequency value, and the second row is a frequency response amplitude in dB, i.e., an amplitude in dB, and the punctuation “ . . . ” represents that n values are omitted.

TABLE 1

| 20 | 21.2 | 22.4 | 23.6 | 25 | . . . | 16000 | 17000 | 18000 | 19000 | 20000 |
|---|---|---|---|---|---|---|---|---|---|---|
| 106.21 | 106.76 | 107.26 | 107.72 | 108.23 | . . . | 88.87 | 89.52 | 83.16 | 79.89 | 77.7 |

The preset target frequency response curve is obtained by calculating an average value of each frequency value based on the frequency response data output by the acoustic test of a batch of products, or may be directly obtained based on experience. The preset target frequency response curve can be represented by a Golden curve. In the embodiment, data corresponding to the preset target frequency response curve is shown in Table 2. Table 2 shows a data 102 pattern corresponding to the preset target frequency response curve, the first row is a frequency value, the second row is an amplitude in dB, and the middle punctuation “ . . . ” represents that n values are omitted.

TABLE 2

| 20 | 21.2 | 22.4 | 23.6 | 25 | . . . | 16000 | 17000 | 18000 | 19000 | 20000 |
|---|---|---|---|---|---|---|---|---|---|---|
| 107.19 | 107.72 | 108.21 | 108.66 | 109.15 | . . . | 87.12 | 77.91 | 72.63 | 69.30 | 66.98 |

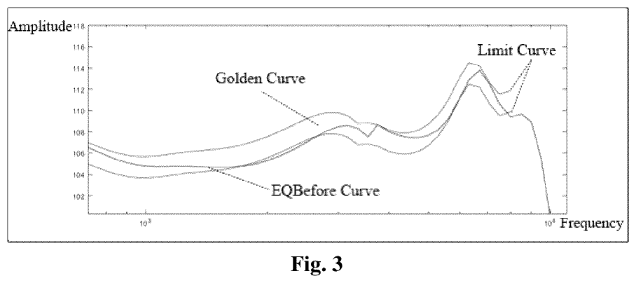

In the embodiment, in order to more intuitively determine a relationship between the frequency response data (EQBefore) and the preset target frequency response curve (EQBefore), reference may be made to FIG. 3, which shows a curve diagram of EQBefore, Golden, and Limit. It should be noted that in FIG. 3, the horizontal axis is frequency, and the vertical axis is amplitude in dB. Here, the Golden curve is a target reference curve, and the EQBefore curve is infinitely close to the Golden curve.

Step S20: determining whether the frequency response data meets the calibration condition according to the target frequency response curve.

In the embodiment, the control center shifts the frequency response data up and down as a whole to a position closest to the target frequency response curve based on main gain information obtained from the TWS earphone, and then determines whether the shifted frequency response data is within a calibration threshold range corresponding to the target frequency response curve, to determine whether it meets the calibration condition.

It should be noted that the main gain information can be represented by mainGain. The control center firstly calculates a difference (lexp) between the Golden and EQBefore data at each corresponding frequency value and averages all lexps within the calibration threshold range to obtain the mainGain.

The calibration threshold range is a calibration threshold limit, which is an acceptable upper and lower deviation range centered on the Golden curve, and can be expressed as Limit. The frequency value corresponds to a frequency value of the Golden data, or may be a frequency section of the Golden data. The Limit has an upper limit (limitUp) and a lower limit (limitDown) representing an acceptable upper deviation range and a lower deviation range, respectively at each frequency value. In the embodiment, data of the calibration threshold range is shown in Table 3. Table 3 shows a data 103 pattern of the calibration threshold range, the first row is a frequency value, the second and third rows are amplitudes in dB, and the punctuation “ . . . ” represents that n values are omitted. The second row is the upper limit of Limit, and the third row is the lower limit of Limit.

TABLE 3

| 30 | 31.5 | 33.5 | 35.5 | 37.5 | . . . | 6300 | 6700 | 7100 | 7500 | 8000 |
|---|---|---|---|---|---|---|---|---|---|---|
| 1 | 1 | 1 | 1 | 1 | . . . | 1 | 1 | 1 | 1 | 1 |
| −1 | −1 | −1 | −1 | −1 | . . . | −1 | −1 | −1 | −1 | −1 |

In the embodiment, in order to observe the range of Limit more intuitively, reference may be made to FIG. 3. In FIG. 3, the Limit curve shows an upper and lower fluctuation range determined with reference to the Golden curve, that is, an acceptable deviation range.

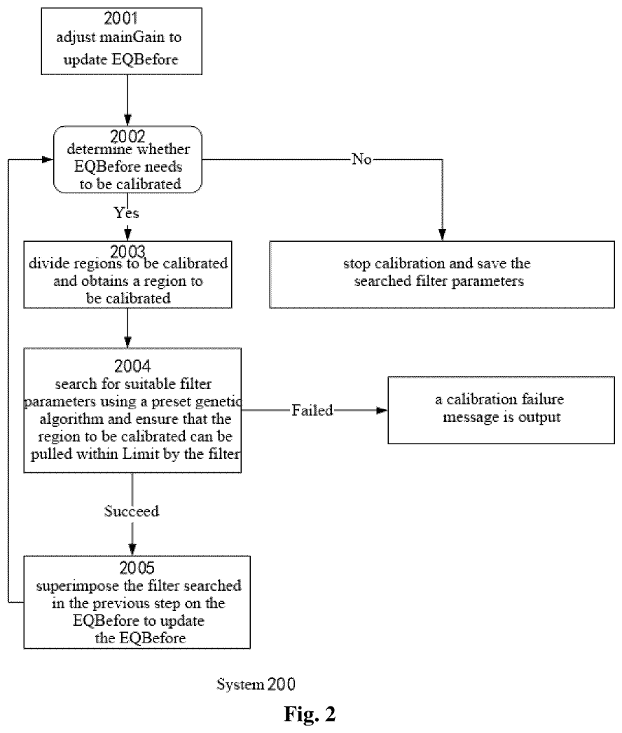

Specifically, as shown in FIG. 2, FIG. 2 is a main process application diagram of an automatic EQ calibration algorithm. The control center firstly adjusts mainGain in module 2001 to shift the frequency response data up and down as a whole to a position closest to the target frequency response curve to update EQBefore, and then determines whether the updated EQBefore needs to be calibrated in module 2002.

In the embodiment, on the one hand, by adjusting mainGain to ensure that EQBefore approaches the Golden curve, it is helpful to more clearly determine whether the frequency response data meets the calibration condition; on the other hand, the EQBefore after being translated by mainGain will definitely form an intersection with the Golden curve, which is also conducive to the operation of performing section dividing in the next step.

Step S30: if it is determined that the frequency response data meets the calibration condition, performing section dividing on the frequency response data, to obtain filter parameters by means of searching based on a preset genetic algorithm, and calibrating the frequency response data according to the filter parameters, to obtain new frequency response data.

In the embodiment, after the control center determines that the frequency response data meets the calibration condition, it determines that the EQBefore and Golden curves form an intersection, and uses the intersections as a section division points to perform section dividing to determine a section to be calibrated, then determines a section to be calibrated to which a maximum deviation position between the EQBefore and Golden belongs, as the current section to be calibrated, and after the control center obtains filter parameters by means of searching based on the preset genetic algorithm, a suitable filter is obtained by means of searching based on the filter parameters and superimposed on the EQBefore, so that the frequency response data is calibrated to obtain new frequency response data.

It should be noted that the filter parameters refer to EQ parameters, specifically representing three parameters: Fc (cutoff frequency), Gain, and Q (quality factor). The section to be calibrated refers to each section divided by the section division point. In addition, it should be noted that the EQBefore between each section is either all greater than Golden or all less than Golden.

In the embodiment, specifically, as shown in FIG. 2, FIG. 2 is a main process application diagram of an automatic EQ calibration algorithm. After the control center determines that the frequency response data needs to be calibrated, it firstly determines an intersection between the EQBefore and Golden curves in module 2003, and then divides regions to be calibrated according to the intersection, and obtains a region to be calibrated according to the maximum deviation position between the EQBefore and Golden as the current region to be calibrated, and then in module 2004, search for suitable filter parameters using a preset genetic algorithm according to the current region to be calibrated to ensure that the current region to be calibrated can be pulled within Limit by the filter, and finally in module 2005, superimpose the filter searched in the previous step on the EQBefore to update the EQBefore. In addition, if a suitable filter cannot be found within a specified evolution generation, a calibration failure message is output and the program stops. Here, the specified evolution generation can be the maximum generation limit set in the genetic algorithm preset by the system.

In the embodiment, by searching for suitable filter parameters using a preset genetic algorithm, the current region to be calibrated can be quickly and easily shrunk within Limit, to achieve the purpose of approaching the frequency response curve of the earphone to be tested, which can not only achieve the consistency in balance between left and right earphones, but also improve the calibration efficiency of the left and right earphones through simple operations to further improve the production efficiency.

Step S40: determining to calibrate the sound quality of the earphone to be calibrated based on the filter parameters when it is determined that the new frequency response data does not meet the calibration condition.

In the embodiment, after determining that the new frequency response data does not need to be calibrated, the control center stops the calibration, and determines the sound quality of the earphone to be calibrated, which is to be acoustically retest based on the filter parameters.

It should be noted that the sound quality of the earphone to be calibrated refers to the consistency in loudness balance of the left and right earphones to be calibrated.

In the embodiment, specifically, as shown in FIG. 2, the control center transmits the updated EQBefore (i.e., new frequency response data) obtained in the module 2005 to the module 2002, and continues to determine whether the updated EQBefore requires calibration; if it is determined that the updated EQBefore does not require calibration, the calibration is stopped and the searched filter parameters are saved. Accordingly, the control center may acoustically retest the sound quality of the earphone to be calibrated based on the filter parameters.

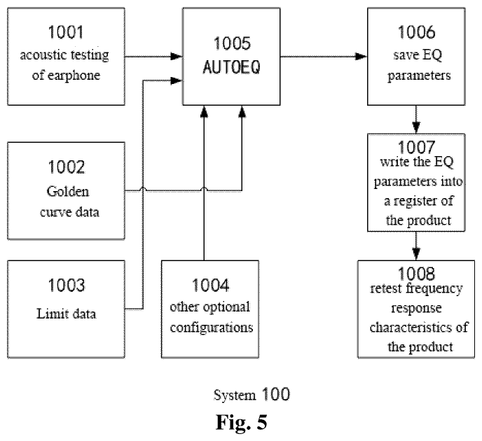

According to the above, as shown in FIG. 5, FIG. 5 is a schematic diagram of a workflow of an automatic EQ calibration algorithm for a production line according to the present disclosure. Appropriate filter parameters are calculated by inputting information obtained from the modules 1001, 1002, 1003 and 1004 in AUTOEQ (a main module of the automatic EQ calibration algorithm, 1005 in the drawings), and operation results are output to module 1006 to maintain EQ parameters, then the EQ parameters are written into a register of the product to be calibrated (1007 in the drawings), and frequency response characteristics of the product may be retested through acoustic testing (1008 in the drawings) to detect whether it meets predetermined requirements. Here, other configurations are optionally set, for example, the maximum number of filters that can be used and the maximum number of generations in the genetic algorithm are optional configurations.

In the present disclosure, a target frequency response curve is provided, a control center firstly determines mainGain of the earphone to be calibrated, and shifts the frequency response data up and down as a whole to a position closest to the target frequency response curve according to the mainGain to obtain an updated EQBefore, then continues to determine whether the EQBefore needs to be calibrated, and then automatically sets EQ filter parameters according to a preset genetic algorithm, and approximates the frequency response data of the earphone to be calibrated to a calibration threshold value within an acceptable upper and lower range centered on the target frequency response curve, to achieve a close frequency response curve for all products, achieve a balanced sound quality between the left and right earphones, and improve product consistency.

Compared with traditional calibration methods for an earphone, the present disclosure provides a target frequency response curve, and ensures that the sound qualities a left earphone and a right earphone of the earphone to be calibrated are consistent, by automatically retrieving filter parameters through a preset algorithm main module, improving the accuracy of the earphone calibration, thereby effectively avoiding a phenomenon in the prior art that tap positions of the earphone are difficult to define and the operation of calibration is complicated. Therefore, by simplifying the earphone calibration process, the quality of the sound quality of the product and the production efficiency of same are improved.

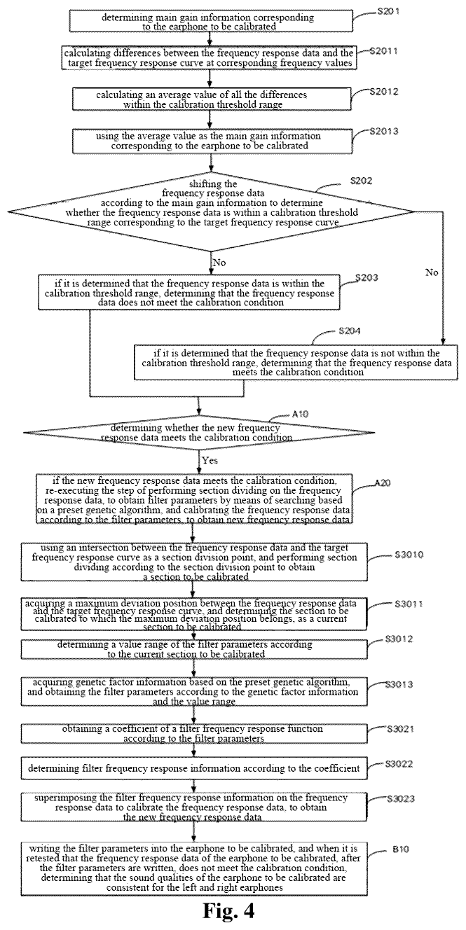

Furthermore, based on the first embodiment of the method of calibrating the sound quality of an earphone of the present disclosure, a second embodiment of the method of calibrating the sound quality of an earphone of the present disclosure is proposed. Referring to FIG. 4, FIG. 4 is a flow chart of a second embodiment of a method of calibrating sound quality of an earphone according to the present disclosure.

In the embodiment, in the above Step S20, the step of determining whether the frequency response data meets the calibration condition according to the target frequency response curve may specifically include:

Step S201: determining main gain information corresponding to the earphone to be calibrated.

The control center firstly obtains differences (lexp) between the Golden and EQBefore data of the earphone to be calibrated at corresponding frequency values within a calibration threshold range, then calculates an average value of all the differences, and uses the average value as the main gain information.

In the embodiment, by determining the differences (lexp) between the Golden and EQBefore data at corresponding frequency values, an average value of all the differences within the calibration threshold range of the earphone to be calibrated can be determined, thereby achieving the effect of obtaining the main gain information of the earphone to be calibrated.

Step S202: shifting the frequency response data according to the main gain information to determine whether the frequency response data is within a calibration threshold range corresponding to the target frequency response curve.

The control center shifts the frequency response data according to the main gain information, and after the frequency response data is shifted to a position closest to the target frequency response curve, the control center determines whether the frequency response data is within the calibration threshold range.

In the embodiment, by adjusting mainGain to translate the EQBefore, an accuracy of the EQBefore approaching the Golden curve can be improved, which is helpful for determining whether the EQBefore meets the calibration condition.

Step S203: if it is determined that the frequency response data is within the calibration threshold range, determining that the frequency response data does not meet the calibration condition.

In the embodiment, after the control center obtains the information that the frequency response data is within the calibration threshold range, it can determine that the frequency response data does not meet the calibration condition.

Step S204: if it is determined that the frequency response data is not within the calibration threshold range, determining that the frequency response data meets the calibration condition.

In the embodiment, after the control center obtains the information that the frequency response data is not within the calibration threshold range, it can determine that the frequency response data meets the calibration condition.

Furthermore, in some embodiments, in the above Step S201, the step of determining main gain information corresponding to the earphone to be calibrated may include:

Step S2011: calculating differences between the frequency response data and the target frequency response curve at corresponding frequency values.

The control center firstly obtains a corresponding frequency value of the frequency response data and the target frequency response curve, and uses a value of the corresponding frequency value on the frequency response data as a first value, and uses a value of the corresponding frequency value on the target frequency response curve as a second value, and then calculates a difference between the second value and the first value, as shown in the following equation 1:

$$lexp = Golden - Before$$

In the embodiment, Golden is the second value, that is, the value of the corresponding frequency value on the target frequency response curve; Before is the first value, that is, the value of the corresponding frequency value on the frequency response data; and lexp represents the difference.

Step S2012: calculating an average value of all the differences within the calibration threshold range.

The control center firstly obtains all the differences lexp within the calibration threshold range, and then calculates an average value based on the total value and total number of the differences lexp, as shown in the following equation 2:

$$mainGain = sum ( lexp [ limitBegin : limitEnd ] ) / ( limitEnd - limitBegin )$$

In the embodiment, limitBegin and limitEnd respectively represent a starting position and an ending position of Limit corresponding to EQBefore; and mainGain represents the main gain information.

In addition, in some embodiments, the EQBefore is translated according to mainGain, and Lexp can be directly shifted, as shown in the following equation 3:

$$lexp = lexp - mainGain$$

wherein, the lexp on the right side of the equation refers to the difference between the Golden and Before data at the corresponding frequency value.

Step S2013: using the average value as the main gain information corresponding to the earphone to be calibrated.

In the embodiment, the control center uses the average value of all differences lexp within the calibration threshold range obtained as the main gain information corresponding to the earphone to be calibrated.

Furthermore, in some embodiments, in the above Step S30, the step of performing section dividing on the frequency response data, to obtain filter parameters by means of searching based on a preset genetic algorithm may include:

Step S3010: using an intersection between the frequency response data and the target frequency response curve as a section division point, and performing section dividing according to the section division point to obtain a section to be calibrated.

The control center determines the section division point by searching for the intersection between the frequency response data and the target frequency response curve, and performs section dividing on the frequency response data according to the section division point to obtain the section to be calibrated.

It should be noted that the operation of the control center to search for a section division point may refer to: if lexp[n] *lexp[n+1]<0, it means that Lexp[n] and Lexp[n+1] have different symbols and the nth data is a section division point.

In the embodiment, the section division point ensures that EQBefore between each section is either all greater than Golden or all less than Golden. At this time, each region can be calibrated only by an IIR (Infinite Impulse Response) filter of PeakEQ (peak parametric equalizer, refers to a way in which an equalizer or filter processes sound signals) type.

Step S3011: acquiring a maximum deviation position between the frequency response data and the target frequency response curve, and determining the section to be calibrated to which the maximum deviation position belongs, as a current section to be calibrated.

After the control center obtains the maximum deviation position between the frequency response data and the target frequency response curve, it can easily determine which section to be calibrated the maximum deviation position falls in, and this section is referred to as the current section to be calibrated.

In the embodiment, a region with the largest deviation is calibrated first, which is beneficial to the calibration of the entire curve. Otherwise, when calibrating the region with the largest deviation, adjacent calibrated regions may be affected to exceed a frame line of the Limit, therefore, it is a good choice to calibrate the region with the largest deviation. The control center takes out the starting position and ending position of this section and then goes to the next step.

Step S3012: determining a value range of the filter parameters according to the current section to be calibrated.

The control center calculates value ranges of the three filter parameters Fc, Q and Gain based on the EQBefore data of the current section to be calibrated. For example, the value range of Fc is between FcMin and FcMax; the value range of Q is between Qmin and QMax; and the value range of Gain is between GainMin and GainMax.

In the embodiment, the control center can obtain values of GainMax and GainMin, that is, the value range of Gain, based on the maximum absolute value and positive and negative symbols of lexp in the section to be calibrated; the control center determines values of QMin and QMax, that is, the value range of Q, based on a frequency width of the section to be calibrated and the maximum Gain value, or they may be pre-set based on experience, for example, QMin is set to 0.1, Qmax is set to 10; the control center sets a frequency value of the starting position of the current region to be calibrated to FcMin, and sets a frequency value of the ending position of the current region to be calibrated to FcMax, that is, the value range of Fc is obtained.

Step S3013: acquiring genetic factor information based on the preset genetic algorithm, and obtaining the filter parameters according to the genetic factor information and the value range.

The control center obtains three genetic factors set in the preset genetic algorithm, and calculates values of Fc, Q, Gain (which are filter parameters) within the value range of the filter parameters based on values of the genetic factors, and the relationship is set as follows (relationship 1):

$$Fc = Fc Min + ( Fc Max - Fc Min ) ⋆ x 1$$

$$Q - Q Min + ( Q Max - Q Min ) ⋆ x 2$$

$$Gain = Gain Min + ( Gain Max - Gain Min ) ⋆ x 3$$

In the embodiment, the IIR filter used herein is of PeakEQ type, and generally, the PeakEQ filter may be intuitively described by three parameters: Fc, Gain, and Q. Therefore, three genetic factors x1, x2, and x3 are set in the preset genetic algorithm, which respectively represent the correlation numbers of the three values of Fc, Gain, and Q to be solved, wherein the value range of x1, x2, and x3 is between 0 and 1.

Furthermore, in some other embodiments, in the above Step S30, the step of calibrating the frequency response data according to the filter parameters, to obtain new frequency response data may include:

Step S3021: obtaining a coefficient of a filter frequency response function according to the filter parameters.

The control center can derive coefficients b0, b1, b2, a0, a1, and a2 of the filter frequency response function based on the three parameters Fc, Q, and Gain.

In the embodiment, coefficients b0, b1, b2, a0, a1, and a2 of the IIR filter frequency response functions are obtained based on the known Fc/gain/Q parameter of the PeakEQ filter, as shown in the following equation 4:
Fs is the sample rate. (Fs represents a sampling rate of the earphone to be calibrated)
Fc is the center (peak) or midpoint (shelf) frequency. (Fc represents a cut-off frequency)
g is the gain. (g represents a gain)
Q is the quality factor (peak) or slope (shelf). (Q is a quality factor)

### Intermediate Variables:

$$A = {10}^{\frac{g}{40}} , w = 2 π \cdot \frac{F c}{F s} , sin = sin ( w ) , cos = cos ( w ) , a = \frac{sin}{2 \cdot Q} , β = \frac{\sqrt{2 A}}{Q}$$

### Peaking Filter:

$${b}_{0} = 1 + a \cdot A , {b}_{1} = - 2 cos , {b}_{2} = 1 - a \cdot A ;$$

$${a}_{0} = 1 + \frac{a}{A} , {a}_{1} = - 2 cos , {a}_{2} = 1 - \frac{a}{A}$$

Step S3022: determining filter frequency response information according to the coefficient.

The control center can determine the filter frequency response information according to the coefficients b0, b1, b2, a0, a1, and a2 of the filter frequency response function. Frequency response H at a corresponding frequency of EQBefore is calculated as shown in the following equation 5:

$$z = e ( 2 ⋆ PI ⋆ ( 1 / fs ) ⋆ freq )$$

$$H = ( b 0 ⋆ z ( 2 ) + b 1 ⋆ z + b 2 ) / ( a 0 ⋆ z ( 2 ) + a 1 ⋆ z + a 2 )$$

In the embodiment, the control center substitutes the coefficients b0, b1, b2, a0, a1, and a2 of the filter frequency response function into the equation 5 to perform a series of calculations to obtain the filter frequency response information, also referred to as response H of the filter frequency at the point freq.

Step S3023: superimposing the filter frequency response information on the frequency response data to calibrate the frequency response data, to obtain the new frequency response data.

The control center superimposes the filter frequency response information (H) searched by the genetic algorithm on the frequency response data to calibrate the frequency response data to obtain new frequency response data, that is, to update EQBefore. The control center may also directly superimpose H on the frequency response data to calibrate the frequency response data to obtain updated lexp.

In the embodiment, for the convenience of calculation, the filter frequency response information, i.e., H, may be directly applied to lexp to obtain a difference between the current lexp and Limit, and then a maximum value of the difference is taken as a fitness, the calculation is shown in the following equation 6:

$$diff = abs ( lexp - 20 ⋆ log 10 ( abs ( H ) ) - ( limitUp - limitDown ) / 2 )$$

$$fitness = max ( diff )$$

It can be seen that the smaller the fitness is, the better the effect of the filter is. When the finesse is less than 0, it means that the filter can calibrate EQBefore to within the range of Limit.

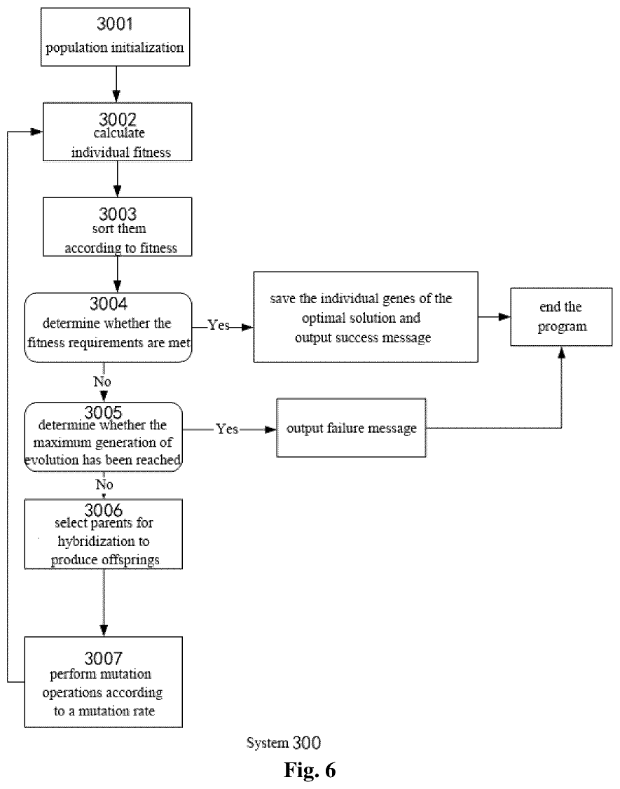

It should be noted that the process of determining the fitness of the filter according to the genetic algorithm is shown in FIG. 6, FIG. 6 is a logic flow diagram of the genetic algorithm in the present disclosure. The number of individuals in the population can be set according to actual needs. A larger population size is more conducive to finding the optimal solution, but the amount of calculation will increase. In the embodiment, the number of individuals in the population can be set to 800. Here, the number of individuals in the population represents the maximum number of filters that can be used. Population initialization (module 3001 in the drawings) refers to assigning a random number to each gene of an individual during initialization (the random number is required to be uniformly distributed), and the random number has a value between 0 and 1.

After the control center determines that the population is initialized, in module 3002, calculate the individual fitness. The fitness of an individual in the current generation population is calculated according to the fitness calculation equation described in the equation 6. After the calculation is completed, an individual has its own fitness value, that is, each filter has a corresponding filtering effect. The control center then calls module 3003 and sorts them according to fitness.

The control center sorts the individuals in the current generation population in ascending order according to the fitness values of the individuals, and then calls module 3004 to determine whether the fitness requirements are met.

The control center determines whether the individual with the best fitness has met the fitness requirements, that is, whether Fitness<0. If so, the individual genes x1, x2, x3 of the optimal solution are saved and the search ends; otherwise, it continues to run downward and calls module 3005 to determine whether the maximum generation of evolution has been reached. If the generation has reached the maximum generation limit, a failure message is output and the evolution is stopped to avoid long-term failure to converge, which causes endless loop of the program.

If the control center determines that the maximum generation of evolution has not been reached, it will continue to run downward and call module 3006 to select parents for hybridization to produce offsprings. In detail, after sorting, the first 400 individuals can be selected as parents to produce 800 offspring through hybridization. Then 2 individuals are randomly selected from the first 400 individuals and an intersection therebetween is randomly selected, wherein the number intersections may be 1 or 2. Then, the selection is repeated 800 times to generate 800 new individuals as new generation population. It should be noted that if the number of the intersections is 1, the first gene is selected from the first individual, and the second and third genes are selected from the second individual as genes of this offspring; if the number of the intersections is 2, the first gene and the second gene are selected from the first individual, and the third gene is selected from the second individual as genes of this offspring.

After the control center determines the new generation population, it calls module 3007 to perform mutation operations according to a mutation rate. It should be noted that there are two purposes for introducing mutation in genetic algorithm: one is to enable the genetic algorithm to have local random search capability, specifically, when the genetic algorithm has approached the neighborhood of the optimal solution through the crossover operator, the local random search capability of the mutation operator can accelerate the convergence to the optimal solution, it is obvious that the mutation probability in this case should be a smaller value, otherwise building blocks close to the optimal solution may be destroyed due to mutation; the other is to enable the genetic algorithm to maintain population diversity to prevent premature convergence, at this time, the mutation probability should take a larger value, wherein the mutation rate is set according to the requirements, if it is too large, convergence may fail, and if it is too small, it is ineffective, the mutation rate in the embodiment may be set to 10%.

The 800 new offspring produced by the new hybridization have a total of 2,400 genes. The control center randomly selects 240 genes from these 2,400 genes and reassigns random values between 0 and 1 to simulate the mutation process.

After the mutation is completed, the control center returns to the module 3002 to recalculate the fitness of an individual in the new generation population.

Furthermore, in some embodiments, before the above Step S40, the following steps are specifically included:

Step A10: determining whether the new frequency response data meets the calibration condition.

In the embodiment, the control center determines whether EQBefore (new frequency response data) is within the range of Limit. If it is within the range of Limit, no calibration is required; otherwise, calibration is required. Whether calibration is required is determined by determining whether all data of lexp are between limitUp and limitDown, and a determination equation is as follows:

$$lexp [ limitBegine : limitEnd ] < limitUp [ : ]$$

$$\& lexp [ limitBegine : limitEnd ] > limitDown [ : ]$$

It should be noted that the calibration condition refers to that the new frequency response data is not within the range of Limit.

Step A20: if the new frequency response data meets the calibration condition, re-executing the step of performing section dividing on the frequency response data, to obtain filter parameters by means of searching based on a preset genetic algorithm, and calibrating the frequency response data according to the filter parameters, to obtain new frequency response data.

When the control center determines that the new frequency response data (EQBefore) is not within the range of Limit, it re-executes the steps of performing section dividing on the updated EQBefore to obtain filter parameters by means of searching based on the preset genetic algorithm, and calibrating the EQBefore according to the filter parameters, to obtain new EQBefore.

In the embodiment, as shown in FIG. 2, the EQBefore updated in the module 2005 is transmitted to the module 2002 to continue to determine whether EQBefore needs to be calibrated. If not, EQBefore is transmitted to the module 2003, and regions to be calibrated are divided according to the EQBefore and a region to be calibrated is obtained. Then, after the filter parameters are obtained based on the preset genetic algorithm in the module 2004, the filter parameters are transmitted to the module 2005 to re-acquire EQBefore.

Furthermore, in some embodiments, after the above Step S40, the following steps are specifically included:

Step B10: writing the filter parameters into the earphone to be calibrated, and when it is retested that the frequency response data of the earphone to be calibrated, after the filter parameters are written, does not meet the calibration condition, determining that the sound qualities of a left earphone and a right earphone of the earphone to be calibrated are consistent.

The control center writes the filter parameters into the earphone to be calibrated, and then retest the frequency response data of the earphone to be calibrated, after the filter parameters are written, by using acoustic test software of the system. If the frequency response data of the earphone to be calibrated, after the filter parameters are written, is within the calibration threshold range, it is determined that the sound qualities of a left earphone and a right earphone of the earphone to be calibrated are consistent.

In the embodiment, as shown in FIG. 5, FIG. 5 is schematic diagram of a workflow of an automatic EQ calibration algorithm for a production line according to the present disclosure. The control center writes the EQ parameters into the register of the product to be calibrated (module 1007 in the drawings), and retests frequency response characteristics of the product through acoustic testing (module 1008 in the drawings) to detect whether it meets predetermined requirements. If the frequency response characteristics of the product are within the calibration threshold range, it is determined that the sound qualities of a left earphone and a right earphone of the earphone to be calibrated are consistent.

Therefore, the present disclosure can quickly search for filter parameters based on the preset genetic algorithm to complete the automatic setting of EQ filter parameters, thereby effectively improving the calibration efficiency of the sound quality of earphone. In addition, by setting the target frequency response curve to limit the calibration threshold range, the calibration accuracy of calibrating the consistency of the left and right earphones is improved to improve the quality of the product; accordingly, the production efficiency of the earphone is further improved with the dual advantages of improved calibration efficiency and improved product quality.

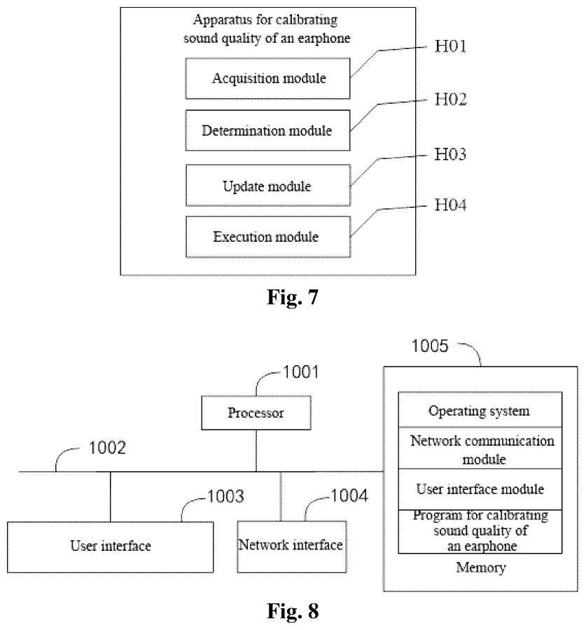

Furthermore, the present disclosure also provides the apparatus for calibrating sound quality of an earphone. Referring to FIG. 7, FIG. 7 is a schematic diagram of modules of apparatus for calibrating sound quality of an earphone according to the present disclosure.

The apparatus for calibrating sound quality of an earphone includes:
an acquisition module H01 configured to acquire frequency response data of an earphone to be calibrated and a preset target frequency response curve;
a determination module H02 configured to determine whether the frequency response data meets a calibration condition according to the target frequency response curve;
an update module H03 configured to perform section dividing on the frequency response data, to obtain filter parameters by means of searching based on a preset genetic algorithm and calibrate the frequency response data according to the filter parameters, to obtain new frequency response data when it is determined that the frequency response data meets the calibration condition; and
an execution module H04 configured to determine to calibrate the sound quality of the earphone to be calibrated based on the filter parameters when it is determined that the new frequency response data does not meet the calibration condition.

Optionally, the determination module H02 includes:
an information determination unit configured to determine main gain information corresponding to the earphone to be calibrated;
a range determination unit configured to shift the frequency response data according to the main gain information to determine whether the frequency response data is within a calibration threshold range corresponding to the target frequency response curve;
a first determination unit configured to, if it is determined that the frequency response data is within the calibration threshold range, determine that the frequency response data does not meet the calibration condition; and
a second determination unit configured to, if it is determined that the frequency response data is not within the calibration threshold range, determine that the frequency response data meets the calibration condition.

Optionally, the determination module H02 further includes:
a difference calculation unit configured to calculate differences between the frequency response data and the target frequency response curve at corresponding frequency values;
an average value calculation unit configured to calculate an average value of all the differences within the calibration threshold range; and
a reference unit configured to use the average value as the main gain information corresponding to the earphone to be calibrated.

Optionally, the update module H03 includes:
a division unit configured to use an intersection between the frequency response data and the target frequency response curve as a section division point, and perform section dividing according to the section division point to obtain a section to be calibrated;
a section acquisition unit configured to acquire a maximum deviation position between the frequency response data and the target frequency response curve, and determine the section to be calibrated to which the maximum deviation position belongs, as a current section to be calibrated;
a range determination unit configured to determine a value range of the filter parameters according to the current section to be calibrated; and
a genetic algorithm unit configured to acquire genetic factor information based on the preset genetic algorithm, and obtain the filter parameters according to the genetic factor information and the value range.

Optionally, the update module H03 further includes:
a coefficient determination unit configured to obtain a coefficient of a filter frequency response function according to the filter parameters;
a frequency response determination unit configured to determine filter frequency response information according to the coefficient; and
a frequency response update unit configured to superimpose the filter frequency response information on the frequency response data to calibrate the frequency response data, to obtain the new frequency response data.

Optionally, the execution module H04 includes:
a condition determination unit configured to determine whether the new frequency response data meets the calibration condition; and
a re-execution unit configured to, if the new frequency response data meets the calibration condition, re-execute the step of performing section dividing on the frequency response data, to obtain filter parameters by means of searching based on a preset genetic algorithm, and calibrate the frequency response data according to the filter parameters, to obtain new frequency response data.

Optionally, the execution module H04 further includes:
an effect determination module configured to writ the filter parameters into the earphone to be calibrated, and when it is retested that the frequency response data of the earphone to be calibrated, after the filter parameters are written, does not meet the calibration condition, determine that the sound qualities of a left earphone and a right earphone of the earphone to be calibrated are consistent.

Each functional module of the apparatus for calibrating the sound quality of an earphone of the present disclosure implements the steps of each embodiment of the method of calibrating the sound quality of an earphone of the present disclosure as described above when running.

Furthermore, the present disclosure also provides a terminal device. Referring to FIG. 8, FIG. 8 is a structural schematic diagram of a terminal device involved in an embodiment of the present disclosure. Specifically, the terminal device in the embodiment of the present disclosure may be a device that adjusts the EQ parameters of the left and right earphones to calibrate the sound quality of the earphone.

As shown in FIG. 8, the terminal device in the embodiment of the present disclosure may include: a processor (e.g., CPU) 1001, a communication bus 1002, a user interface 1003, a network interface 1004, a memory 1005, and a sensing unit 1006. The communication bus 1002 is used to realize connection and communication between these components. The user interface 1003 may include a display, an input unit such as a keyboard, and the user interface 1003 may optionally further include a standard wired interface and a wireless interface. The network interface 1004 may optionally include a standard wired interface or a wireless interface (e.g., a WIFI interface).

The memory 1005 is provided on a main body of the terminal device, and a program is stored in the memory 1005, when the program is executed by the processor 1001, a corresponding operation is implemented. The memory 1005 is also used to store parameters for use by the terminal device. The memory 1005 may be a high-speed RAM memory or a non-volatile memory, such as a disk memory. The memory 1005 may optionally be a storage device independent of the aforementioned processor 1001.

The terminal device may communicate with a user terminal through the network interface 1004. The terminal device may also communicate with a base station through short-range communication technology. Here, the base station is a cleaning device used in conjunction with the terminal device.

Those skilled in the art will appreciate that the terminal device structure shown in FIG. 8 does not constitute a limitation on the terminal device, and may include more or fewer components than shown in the drawings, or a combination of certain components, or a different arrangement of components.

As shown in FIG. 8, the memory 1005, as a storage medium, may include an operating system, a network communication module, a user interface module, and an intelligent connection program of the terminal device.

In the terminal device shown in FIG. 8, the processor 1001 may be used to call the intelligent connection program of the terminal device stored in the memory 1005, and perform the steps of each embodiment of the above-mentioned terminal device for calibrating the sound quality of an earphone of the present disclosure.

It should be noted that terms such as “include”, “include” or any other variation thereof are intended to encompass a non-exclusive inclusion such that a process, method, article or apparatus that includes a series of elements includes not only those elements, but also other elements not explicitly listed, or elements inherent to such a process, method, article or apparatus. Without further limitation, the element defined by the phrase “including a . . . ” does not preclude the presence of additional identical elements in the process, method, article or apparatus including the element.

The serial numbers of the above-mentioned embodiments of the present disclosure are for description only and do not represent the advantages or disadvantages of the embodiments.

According to the description of the above implementations, those skilled in the art can clearly understand that the above embodiment methods can be implemented by means of software plus a necessary general hardware platform, and of course by hardware, but in many cases the former is a better implementation. Based on this understanding, the technical solution of the present disclosure can essentially or a part that contributes to the prior art can be embodied in the form of a software product. The computer software product is stored in a storage medium (e.g., ROM/RAM, disk, or CD) as described above, and includes a series of instructions for enabling a terminal device (which may be a mobile phone, a computer, a server, an air conditioner, or a network device, etc.) to execute the methods described in the various embodiments of the present disclosure.

The above are only preferred embodiments of the present disclosure, and are not intended to limit the patent scope of the present disclosure. Any equivalent structure or equivalent process transformation made using the contents of specification and drawings of the present disclosure, or directly/indirectly applications in other related technical fields, are included in the patent scope of the present disclosure.

1. A method of calibrating sound quality of an earphone, comprising steps of:
acquiring frequency response data of an earphone to be calibrated and a preset target frequency response curve;
determining whether the frequency response data meets the calibration condition according to the target frequency response curve;
if it is determined that the frequency response data meets the calibration condition, performing section dividing on the frequency response data, to obtain filter parameters by means of searching based on a preset genetic algorithm, and calibrating the frequency response data according to the filter parameters, to obtain new frequency response data; and
determining to calibrate the sound quality of the earphone to be calibrated based on the filter parameters when it is determined that the new frequency response data does not meet the calibration condition.

2. The method of claim 1, wherein the step of determining whether the frequency response data meets the calibration condition according to the target frequency response curve comprises:
determining main gain information corresponding to the earphone to be calibrated;
shifting the frequency response data according to the main gain information to determine whether the frequency response data is within a calibration threshold range corresponding to the target frequency response curve;
if it is determined that the frequency response data is within the calibration threshold range, determining that the frequency response data does not meet the calibration condition; and
if it is determined that the frequency response data is not within the calibration threshold range, determining that the frequency response data meets the calibration condition.

3. The method of claim 2, wherein the step of determining the main gain information corresponding to the earphone to be calibrated comprises:
calculating differences between the frequency response data and the target frequency response curve at corresponding frequency values;
calculating an average value of all the differences within the calibration threshold range; and
using the average value as the main gain information corresponding to the earphone to be calibrated.

4. The method of claim 1, wherein the step of performing the section dividing on the frequency response data, to obtain the filter parameters by means of searching based on the preset genetic algorithm comprises:
using an intersection between the frequency response data and the target frequency response curve as a section division point, and performing the section dividing according to the section division point to obtain a section to be calibrated;
acquiring a maximum deviation position between the frequency response data and the target frequency response curve, and determining the section to be calibrated to which the maximum deviation position belongs, as a current section to be calibrated;
determining a value range of the filter parameters according to the current section to be calibrated; and
acquiring genetic factor information based on the preset genetic algorithm, and obtaining the filter parameters according to the genetic factor information and the value range.

5. The method of claim 1, wherein the step of calibrating the frequency response data according to the filter parameters, to obtain the new frequency response data comprises:
obtaining a coefficient of a filter frequency response function according to the filter parameters;
determining filter frequency response information according to the coefficient; and
superimposing the filter frequency response information on the frequency response data to calibrate the frequency response data, to obtain the new frequency response data.

6. The method of claim 1, further comprising steps of: before the step of determining to calibrate the sound quality of the earphone to be calibrated based on the filter parameters when it is determined that the new frequency response data does not meet the calibration condition,
determining whether the new frequency response data meets the calibration condition; and
if the new frequency response data meets the calibration condition, re-executing the step of performing the section dividing on the frequency response data, to obtain the filter parameters by means of searching based on the preset genetic algorithm, and calibrating the frequency response data according to the filter parameters, to obtain new frequency response data.

7. The method of claim 1, further comprising steps of: after the step of determining to calibrate the sound quality of the earphone to be calibrated based on the filter parameters,
writing the filter parameters into the earphone to be calibrated, and when it is retested that the frequency response data of the earphone to be calibrated, after the filter parameters are written, does not meet the calibration condition, determining that the sound qualities of a left earphone and a right earphone of the earphone to be calibrated are consistent.

8. An apparatus for calibrating sound quality of an earphone, comprising:
an acquisition module configured to acquire frequency response data of an earphone to be calibrated and a preset target frequency response curve;
a determination module configured to determine whether the frequency response data meets a calibration condition according to the target frequency response curve;
an update module configured to perform section dividing on the frequency response data, to obtain filter parameters by means of searching based on a preset genetic algorithm and calibrate the frequency response data according to the filter parameters, to obtain new frequency response data when it is determined that the frequency response data meets the calibration condition; and
an execution module configured to determine to calibrate sound quality of the earphone to be calibrated based on the filter parameters when it is determined that the new frequency response data does not meet the calibration condition.

9. A terminal device, comprising: a memory, a processor, and
a program for calibrating sound quality of an earphone stored in the memory and executable by the processor,
wherein the program for calibrating sound quality of an earphone, when executed by the processor, implements the steps of the method of claim 1.

10. A non-transitory storage medium, on which a program for calibrating sound quality of an earphone is stored,
wherein when the program for calibrating sound quality of an earphone is executed by a processor, the steps of the method of claim 1 are implemented.
